(19) United States
(12) Patent Application Publication
(10) Pub. No.: US 2014/0052318 A1
(43) Pub. Date: Feb. 20, 2014

(54) VEHICLE CONTROLLER AND HYBRID VEHICLE

(71) Applicant: Kabushiki Kaisha Toshiba, Tokyo (JP)

(72) Inventors: Hiroshi YOSHIDA, Tokyo (JP); Min LIN, Tokyo (JP); Masanao ITO, Tokyo (JP); Atsushi YAJIMA, Tokyo (JP)

(21) Appl. No.: 13/934,752

(22) Filed: Jul. 3, 2013

(30) Foreign Application Priority Data
Aug. 17, 2012 (JP) 2012-181038

(51) Int. Cl. B60W 20/00; B60W 10/196; B60W 10/08

(52) U.S. Cl. CPC B60W 20/00; B60W 10/08; B60W 10/196; B60W 2600/00; Y10S 903/93
USPC 701/22; 180/65.265; 903/930

(57) ABSTRACT

In a set of hybrid vehicles including first and second hybrid vehicles connected in series, each of the hybrid vehicles having an electric storage device, a controller for the first hybrid vehicle comprises a monitoring unit configured to detect an amount of electric charge stored in the electric storage device of the first hybrid vehicle, a communication unit configured to carryout communication with a communication unit of at least the second hybrid vehicle to acquire an amount of electric charge stored in the electric storage device of the second hybrid vehicle, and a control unit configured to determine load shares of the first and second hybrid vehicles during operation of the first and second hybrid vehicles, on the basis of the amount of electric charge stored in the electric storage devices thereof.

### CROSS-REFERENCE TO RELATED APPLICATION

This application is based upon and claims the benefit of priority from Japanese Patent Application No. 2012-181038, filed Aug. 17, 2012, the entire contents of which are incorporated herein by reference.

### FIELD

Embodiments described herein relate generally to a vehicle controller and a hybrid vehicle.

### BACKGROUND

In the related art, there are railway vehicles that are driven by power from a combination of generators driven by engines or a main power supply supplied from overhead lines and an electric storage device (hereinafter to be referred to as hybrid vehicles). For the hybrid vehicles, energy generated during brake operation is stored in the electric storage device, and the stored energy can be reused as a portion of energy needed for powering the hybrid vehicles as needed. In this way, it is possible to realize energy-conservation while driving the hybrid vehicles.

However, when plural hybrid vehicles connected with each other are controlled in the related art, the same control is carried out on all of the connected hybrid vehicles. Consequently, for example, in a train including plural hybrid vehicles that are connected with each other, there is dispersion in the states (stored charge quantities, temperatures, degradation states, etc.) among the electric storage devices in the respective hybrid vehicles. For a hybrid vehicle with a larger stored charge quantity, the energy generated during brake operation may be over absorbed by the electric storage device, so that the energy becomes thermal energy and discarded. As a result, such energy cannot be well reused. On the other hand, for a hybrid vehicle with less stored charge quantity, the energy that can be reused as a portion of the energy needed for powering the hybrid vehicle is insufficient, so that electric power consumed from the main power supply becomes higher. In this way, due to the dispersion in the states among the electric storage devices of the respective hybrid vehicles, the energy-conservation performance of the overall train may be degraded.

### DESCRIPTION OF THE DRAWINGS

FIG. 1 is a diagram illustrating an example of a train according to a first embodiment.

FIG. 2 is a block diagram illustrating an example of the configuration of the train according to the first embodiment.

FIG. 3 is a flow chart illustrating an example of the operation of a vehicle information controller.

FIG. 4 is a flow chart illustrating an example of the operation of the vehicle information controller.

FIG. 5 is a block diagram illustrating an example of the configuration of a train according to a second embodiment.

FIG. 6 is a block diagram illustrating an example of the configuration of a train according to a third embodiment.

### DETAILED DESCRIPTION

Embodiments provide a vehicle controller that can improve the energy-conservation performance of a train having a plurality of connected hybrid vehicles each having an electric storage device, and hybrid vehicles each having the vehicle controller.

According to an embodiment, in a set of hybrid vehicles including first and second hybrid vehicles connected in series, each of the hybrid vehicles having an electric storage device, a controller for the first hybrid vehicle comprises a monitoring unit configured to detect an amount of electric charge stored in the electric storage device of the first hybrid vehicle, a communication unit configured to carry out communication with a communication unit of at least the second hybrid vehicle to acquire an amount of electric charge stored in the electric storage device of the second hybrid vehicle, and a control unit configured to determine load shares of the first and second hybrid vehicles during operation of the first and second hybrid vehicles, on the basis of the amount of electric charge stored in the electric storage devices thereof.

According to another embodiment, a system of hybrid vehicles connected in series comprises a first hybrid vehicle including an electric storage device, and a monitoring unit configured to detect an amount of electric charge stored in the electric storage device, and a second hybrid vehicle including an electric storage device, and a monitoring unit configured to detect an amount of electric charge stored in the electric storage device. Load shares for the first and second hybrid vehicles are respectively determined from an amount of electric charge stored in the electric storage devices of the first and second hybrid vehicles.

The vehicle controller and the hybrid vehicles according to the embodiments of the present invention will be explained in detail with reference to the attached drawings. As the same composing requirements are contained in the plural embodiments to be presented below, the same keys are adopted to represent them, and they will not be explained in detail repeatedly.

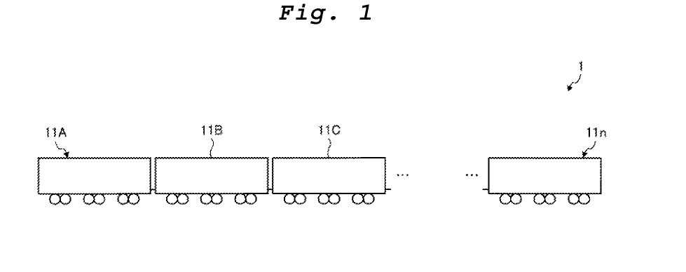

FIG. 1 is a diagram illustrating an example of a train 1 according to a first embodiment. As shown in FIG. 1, the train 1 has a first power vehicle 11A, a second power vehicle 11B, a third power vehicle 11C, . . . , and an n^{th} power vehicle 11n that are connected to each other. The first power vehicle 11A, the second power vehicle 11B, the third power vehicle 11C, . . . , and the n^{th} power vehicle 11n are driven by electric power supplied from main power supplies and/or the electric power supplied from electric storage devices. They are hybrid vehicles that allow charging of the electric storage devices during brake operation by regenerating electric power from the brake energy. Here, in the example shown in FIG. 1, trailers are not described. Of course, the train 1 may also have plural trailers connected thereto.

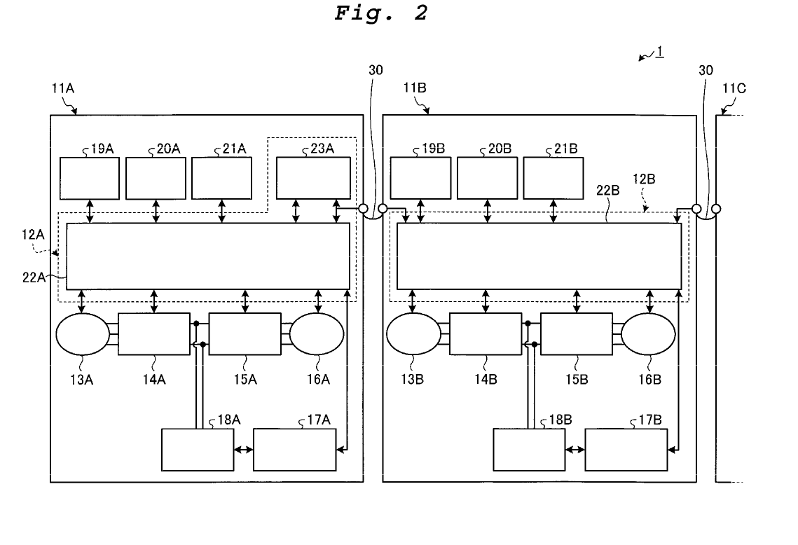

FIG. 2 is a block diagram illustrating an example of the configuration of the train 1 according to the first embodiment. As shown in FIG. 2, the first power vehicle 11A, the second power vehicle 11B, the third power vehicle 11C, . . . are connected with each other by a transmission line (transmission line, transfer line) 30. This transmission line 30 may also be a trunk-type Local Area Network (LAN) connected to the respective vehicles in a ring topology of the train 1. As a result, for example, a vehicle information controller 12A of the first power vehicle 11A and a vehicle information controller 12B of the second power vehicle 11B may carry out information transmission/reception between them. Also, the vehicle information controller 12A of the first power vehicle 11A and a vehicle information controller (not shown) of the third power vehicle 11C can carry out information transmission/reception between them via the vehicle information controller 12B of the second power vehicle 11B. A wireless network may be used for the transmission line 30.

The first power vehicle 11A and the second power vehicle 11B (and the third power vehicle 11C through the n^{th} power vehicle 11n) are the hybrid vehicles with the same configuration except that the first power vehicle 11A includes a formation management section 23A. Consequently, in the following, only the configuration of the first power vehicle 11A will be explained in detail, while the second power vehicle 11B (and the third power vehicle 11C through the n^{th} power vehicle 11n) will not be explained in detail.

The first power vehicle 11A has a generator 13A, a converter 14A, an inverter 15A, a motor 16A as a power source (driving source), an electric storage device 18A, an electric storage device monitoring controlling section 17A, an operation section 19A, a display unit 20A, a pneumatic brake 21A, and the vehicle information controller 12A. The first power vehicle 11A is a so-called hybrid drive-type power vehicle that has the electric power supplied from the generator 13A and the electric storage device 18A to the motor 16A.

The generator 13A is driven by a diesel engine or other power source (not shown) arranged on the first power vehicle 11A, and it generates an AC power.

The converter 14A converts the AC power output from the generator 13A to a DC power. The inverter 15A converts the DC power output from the converter 14A to an AC power. Also, the inverter 15A converts a DC power output from the electric storage device 18A to an AC power.

The motor 16A works with the AC power output from the inverter 15A. Also, the motor 16A works with the electric power supplied from the electric storage device 18A. In this way, the electric power is supplied from the generator 13A and the electric storage device 18A to the motor 16A. The motor 16A drives wheels (not shown) arranged on the first power vehicle 11A, so that the first power vehicle 11A is driven to run. That is, the first power vehicle 11A can be driven to run by the operation of the motor 16A. For the motor 16A, an output can be changed by changing the notch number. As an example, when the notch number is decreased, it is possible to decrease the output power. Also, the motor 16A works as a regenerating brake during brake operation, and generates regenerated electric power. The regenerated electric power is supplied via the inverter 15A to the electric storage device 18A. In this case, the inverter 15A works as an converter to convert the AC power generated by the motor 16A to a DC power that is supplied to the electric storage device 18A. In this way, the regenerated electric power generated by the motor 16A is charged in the electric storage device 18A, so that the regenerating brake works. The regenerating brake generates a braking force that brakes the first power vehicle 11A.

The electric storage device 18A stores the DC power obtained by the converter 14A as it converts the AC power generated by the generator 13A. The electric storage device 18A stores the regenerated electric power generated by the motor 16A. In this way, the electric storage device 18A can charge the electric power generated by the generator 13A and the regenerated electric power generated by the motor 16A. Also, the electric storage device 18A is not limited to the scheme that both the electric power generated by the generator 13A and the regenerated electric power generated by the motor 16A can be charged. At least the electric power generated by one of the generator 13A and the motor 16A can be charged. Also, the electric storage device 18A can discharge (output) the electric power to the inverter 15A. The electric storage device 18A may be a nickel hydrogen battery pack or a lithium ion battery pack. The electric storage device 18A is not limited to the nickel hydrogen battery pack, the lithium ion battery pack, and other secondary batteries. For example, it may also be made of capacitors, or other devices with a charge storage function.

The electric storage device monitoring controlling section 17A controls charging/discharge of the electric storage device 18A. Also, the electric storage device monitoring controlling section 17A detects the state (stored charge quantity (state of charge), temperature, degradation state) of the electric storage device 18A. More specifically, the electric storage device monitoring controlling section 17A measures the current quantity in charging/discharge of the electric storage device 18A and a voltage of the electric storage device 18A, and it computes the state of charge (SOC) of the electric storage device 18A. The state of charge refers to the proportion of the stored charge quantity with respect to the fully stored charge quantity of the electric storage device 18A. Also, on the basis of an output from a temperature sensor set inside the electric storage device 18A, the electric storage device monitoring controlling section 17A detects the temperature of the electric storage device 18A. Also, the electric storage device monitoring controlling section 17A works as follows: on the basis of the charging/discharge depth based on the age of use counted from the time of setting of the electric storage device 18A, the number or rounds of charging/discharge obtained by counting the charging/discharge cycles, the internal resistance value obtained by measuring the current and voltage of the electric storage device 18A, and the discharge quantity with respect to the rated capacity of the electric storage device 18A, the degradation index of the electric storage device 18A is computed with reference to data that describes the corresponding relationship between the age of use, the charging/discharge round number, the internal resistance value, and the value of the charging/discharge depth versus the degradation index that indicates the degree of degradation.

The electric storage device monitoring controlling section 17A notifies the vehicle information controller 12A about the state of the electric storage device 18A that has been detected. Together with the state of the electric storage device 18A of the host vehicle notified by the electric storage device monitoring controlling section 17A, the vehicle information controller 12A also acquires the state of the electric storage devices notified to the vehicle information controllers of the respective vehicles via the transmission line 30.

The operation section 19A includes a master controller (mas-con), etc., and it receives operation instructions from a driver. The operation section 19A inputs a running instruction which includes instructions for, e.g., the power running, coasting, deceleration (brake), etc.

The display unit 20A may be a liquid crystal display unit, and it displays various types of information. The display unit 20A, together with the operation section 19A, is arranged, e.g., in front of a driver's seat.

The pneumatic brake 21A includes a pneumatic mechanism, and it generates a brake force for the first power vehicle 11A by friction. The pneumatic brake 21A is different from the regenerating brake, and it is another example of the brake. Also, other types of brakes are not limited to the pneumatic brake 21A. For example, one may also use a power generation brake that generates a braking force by consumption by a resistor (not shown) carried on the first power vehicle 11A instead of charging the electric storage device 18A with the regenerated electric power generated by the motor 16A electric.

Connected to the vehicle information controller 12A are the generator 13A, the converter 14A, the inverter 15A, the motor 16A, the electric storage device 18A, the electric storage device monitoring controlling section 17A, the operation section 19A, the display unit 20A, and the pneumatic brake 21A. While monitoring the respective sections of the first power vehicle 11A, the vehicle information controller 12A controls the respective sections of the first power vehicle 11A. Also, under the running instruction generated by the operation of the operation section 19A, the vehicle information controller 12A sends the instruction for power running, coasting, and deceleration (braking) for the entirety of the train 1 (the first power vehicle 11A, the second power vehicle 11B, the third power vehicle 11C, . . . , and the n^{th} power vehicle 11n), so that load shares for the hybrid vehicles are controlled as the train 1 runs.

More specifically, the vehicle information controller 12A has a Central Processing Unit (CPU), a Read-Only Memory (ROM), and a Random Access Memory (RAM) (all not shown). As the CPU works according to a program stored in the ROM, it realizes functions of a control section 22A and the formation management section 23A.

The control section 22A controls the respective sections of the first power vehicle 11A. Specifically, the control section 22A controls so that the operation section 19A receives the operation, the display unit 20A displays, and the instructions by the formation management section 23A about the power running, coasting, and deceleration (braking) as the load share for the first power vehicle 11A control of the generator 13A, the converter 14A, the inverter 15A, the motor 16A, the electric storage device 18A, and the pneumatic brake 21A, are carried out.

For example, in a power running mode, the control section 22A has the generator 13A and/or the electric storage device 18A supply the electric power to the motor 16A so that the motor 16A works and the first power vehicle 11A is driven to run. On the other hand, in a deceleration mode (brake operation), the control section 22A has the electric power supplied to the electric storage device 18A from the generator 13A and/or the motor 16A for charging the electric storage device 18A. As an example, the state of charge of the electric storage device 18A in charging/discharge operation decreases due to discharge in the power running mode, and it increases due to charging in the deceleration mode.

The formation management section 23A collects the overall information of the train 1 via the transmission line 30, and it manages the entire train 1 (the first power vehicle 11A, the second power vehicle 11B, the third power vehicle 11C, . . . , and the n^{th} power vehicle 11n). More specifically, the formation management section 23A acquires the various types of information, such as the state (stored charge quantity (state of charge), temperature, degradation state) of the electric storage devices detected by the electric storage device monitoring controlling sections of the respective hybrid vehicles of the first power vehicle 11A, the second power vehicle 11B, the third power vehicle 11C, . . . , and the n^{th} power vehicle 11n. This information collection is carried out at the timing of the operation of the operation section 19A or once every prescribed period (e.g., a few seconds). Also, on the basis of the running instruction by the operation of the operation section 19A, the formation management section 23A controls the load shares for the respective hybrid vehicles when the train 1 is running on the basis of the states of the electric storage devices acquired from the hybrid vehicles, that is, the first power vehicle 11A, the second power vehicle 11B, the third power vehicle 11C, . . . , and the n^{th} power vehicle 11n, so that the states of the electric storage devices of the respective hybrid vehicles become the same or the difference between the states of the electric storage devices fall into a predetermined value.

As shown above, the keys representing the respective sections of the first power vehicle 11A have “A” attached to their tails. On the other hand, the keys representing the respective sections of the second power vehicle 11B are indicated by attaching “B”. That is, the second power vehicle 11B has a generator 13B, a converter 14B, an inverter 15B, a motor 16B, an electric storage device 18B, an electric storage device monitoring controlling section 17B, an operation section 19B, a display unit 20B, a pneumatic brake 21B, and the vehicle information controller 12B. Also, the vehicle information controller 12B has a control section 22B. According to the present embodiment, the electric storage device 18A of the first power vehicle 11A and the electric storage device 18B of the second power vehicle 11B are not electrically connected to each other. Instead, they are independent from each other.

The vehicle information controller 12A has the formation management section 23A in this configuration. In other embodiments, the formation management section may be implemented in other vehicle information controllers, e.g., the vehicle information controller 12B. The functional section corresponding to the formation management section is set in a vehicle information controller of a power vehicle that is instructed to work as such, when the driver inserts a working card into the operation section.

In the following, the control for the load shares of the respective hybrid vehicles (first power vehicle 11A, second power vehicle 11B, third power vehicle 11C, . . . , and n^{th} power vehicle 11n) when the train 1 runs will be explained in detail.

According to the stored charge quantities (state of charge) of the electric storage devices acquired from the hybrid vehicles, the formation management section 23A controls the load shares of the hybrid vehicles when the train 1 is running so that the stored charge quantities (state of charge) of the electric storage devices of the hybrid vehicles become the same.

More specifically, in the power running mode when the operation section 19A provides the power running notch, the formation management section 23A uses the following listed formula (1) to compute power running output shares for the hybrid vehicles.

$$\begin{matrix}[ Numeric 1 ] & \\ \begin{matrix}PRef\_ 1 = f 1 ( SOC\_ 1 ) \times PRef = K1\_ 1 \times PRef \\ ⋮ \\ PRef\_N = f 1 ( SOC\_N ) \times PRef = K1\_N \times PRef\end{matrix} \} & ( 1 )\end{matrix}$$

Here, the underbars and the 1 through N annexed letters indicate the numbers of the power vehicles. For example, PRef_{—}1 indicates a power running output value of the first power vehicle 11A, PRef_N indicates a power running output value of the n^{th} power vehicle 11n. The PRef used for calculating each of the power running output values PRef_{—}1 through PRef_N indicates the total power running output. Also, SOC_{—}1 through SOC_N represent the stored charge quantities (state of charge) of the hybrid vehicles. f1( ) is a power running share computing function for computing the power running output shares corresponding to the stored charge quantities (sate of charge). K1_{—}1 through K1_N are power running share coefficients computed using the power running share computing function.

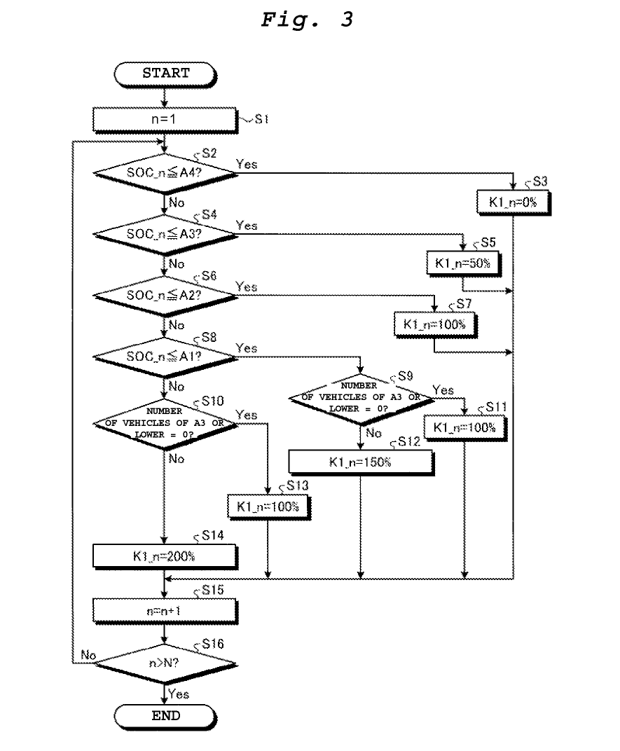

FIG. 3 is a flow chart illustrating an example of the operation of the vehicle information controller 12A. More specifically, it is a flow chart illustrating the operation when the power running share coefficients (K1_{—}1 through K1_N) are computed using the power running share computing function.

As shown in FIG. 3, the formation management section 23A sets a variable n to 1 so that an initial power vehicle is selected (S1). Then, the formation management section 23A carries out the process of steps S2 through S14 for the power vehicle with the number n. More specifically, the formation management section 23A compares a value of SOC_n with preset values A4 through A1 (set value A1>set value A2>set value A3>set value A4), and the stored charge quantities (state of charge) are classified to 4 levels (S2, S4, S6, S8).

When the stored charge quantity (state of charge) is of the set value A4 or smaller (S2: YES), and the stored charge quantity (state of charge) is on the lowest level, the formation management section 23A sets K1_n=0% (S3). That is, for the power vehicle with the number n, the power running share is set at 0%.

When the stored charge quantity (state of charge) is larger than the set value A4 and of the set value 3 or smaller (S4: YES), the formation management section 23A sets K1_n=50% (S5). That is, for the power vehicle with the number n, the power running share is set at 50%.

When the stored charge quantity (state of charge) is larger than the set value A3 and of the set value A2 or smaller (S6: YES), the formation management section 23A sets K1_n=100% (S7). That is, for the power vehicle with the number n, the power running share is set at 100%.

When the stored charge quantity (state of charge) is larger than the set value A2 and of the set value 1 or smaller (S8: YES), the formation management section 23A determines whether the number of the vehicles with the set value A3 or lower in the train 1 is 0 (S9). If there exists no vehicle with the set value A3 or lower, and the number of the vehicles is 0 (S9: YES), the formation management section 23A sets K1_n=100% (S11). When there exist vehicles with the set value A3 or lower, and the number of the vehicles is not 0 (S9: NO), the formation management section 23A sets K1_n=150% (S12). That is, for the power vehicle with the number n, the power running share is set at 150% so that they can pick up the power running output insufficiency due to presence of the vehicles with the set value A3 or lower.

When the stored charge quantity (state of charge) is larger than the set value A1 (S8: NO), the formation management section 23A determines whether the number of the vehicles of the set value A3 or lower in the train 1 is 0 (S10). If there exists no vehicle of the set value A3 or lower, and the vehicle number is 0 (S10: YES), the formation management section 23A sets K1_n=100% (S13). When there exist the vehicles of the set value A3 or lower, and the vehicle number is not 0 (S10: NO), the formation management section 23A sets K1_n=200% (S14). That is, for the power vehicle with the number n, as there is a sufficient state of charge, the power running share is set at 200%, so that it picks up the power running output insufficiency due to presence of the vehicles of the set value A3 or lower.

Then, the formation management section 23A increments the variable n (S15), and determines whether the variable n is greater than the number (N) of the power vehicles in the train 1 (S16). When the variable n is greater than the number (N) of the power vehicles of the train 1 (S16: YES), it is determined that the power running shares for all of the power vehicles in the train 1 have been computed, so the process comes to an end. When the variable n is the number (N) of the power vehicles of the train 1 or smaller (S16: NO), it returns to step S2, and the power running share of the next power vehicle is computed.

Also, it is possible to set the power running share coefficients (K1_{—}1 through K1_N) as continuous functions of SOC_{—}1 through SOC_N. The level classification and the power running share coefficients (0%, 50%, 100%, 150%, 200%) shown in the flow chart in FIG. 3 are merely an example, and they may be set corresponding to the actual state of the connected power vehicles correlated to some capacity of the power vehicles.

The formation management section 23A notifies the hybrid vehicles with the computed power running output values (PRef_{—}1 through PRef_N) as power running instruction values. According to the power running instruction values of the formation management section 23A, the controllers of the hybrid vehicles carry out the power running. Here, the power running output value may also be an inverter current instruction, an inverter torque instruction, or a power running instruction. Due to the power running shares, there is less dispersion in the stored charge quantities of the electric storage devices of the hybrid vehicles of the train 1. Consequently, it is possible to make a high-efficiency use of the electric storage devices of the hybrid vehicles connected with each other, so that it is possible to improve the energy-conservation performance for the overall train 1 while running.

When the operation section 19A sends in a brake instruction (brake command), the formation management section 23A computes brake shares of the hybrid vehicles (regeneration shares) according to the following listed formula (2).

$$\begin{matrix}[ Numeric 2 ] & \\ \begin{matrix}BRef\_ 1 = f 2 ( SOC\_ 1 ) \times BRef = K2\_ 1 \times BRef \\ ⋮ \\ BRef\_N = f2 ( SOC\_N ) \times BRef = K2\_N \times BRef\end{matrix} \} & ( 2 )\end{matrix}$$

Here, the underbars and the 1 through N annexed letters indicate the numbers of the power vehicles. For example, BRef_{—}1 indicates a brake instruction value of the first power vehicle 11A, BRef_N indicates a brake instruction value of the n^{th} power vehicle 11n. The BRef used for calculating each of the brake instruction values BRef_{—}1 through BRef_N indicates the total brake instruction value. Also, f2( ) is a brake share computing function for computing the brake shares (regeneration shares) corresponding to the stored charge quantity (state of charge). K2_{—}1 through K2_N are brake (regeneration) share coefficients computed using the brake share computing function.

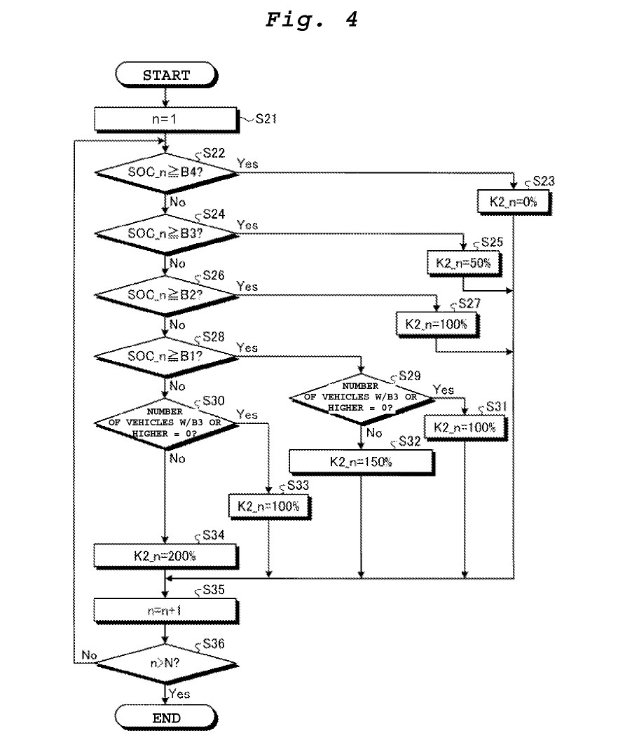

FIG. 4 is a flow chart illustrating an example of the operation of the vehicle information controller 12A. More specifically, it is a flow chart illustrating the operation when the brake share coefficients (K2_{—}1 through K2_N) are computed using the brake share computing function.

As shown in FIG. 4, the formation management section 23A sets a variable n to 1 so that an initial power vehicle is selected (S21). Then, the formation management section 23A carries out the process of steps S22 through S34 for the power vehicle with the number n. More specifically, the formation management section 23A compares a value of SOC_n with preset values B4 through B1 (set value B1<set value B2<set value B3<set value B4), and the stored charge quantities (state of charge) are classified to 4 levels (S22, S24, S26, S28).

When the stored charge quantity (state of charge) is of the set value B4 or larger (S22: YES), and the stored charge quantity (state of charge) is on the highest level, the formation management section 23A sets K2_n=0% (S23). That is, for the power vehicle with the number n, the brake share is set at 0%.

When the stored charge quantity (state of charge) is smaller than the set value B4 and of the set value B3 or larger (S24: YES), the formation management section 23A sets K2_n=50% (S25). That is, for the power vehicle with the number n, the brake share is set at 50%.

When the stored charge quantity (state of charge) is smaller than the set value B3 and of the set value B2 or larger (S26: YES), the formation management section 23A sets K2_n=100% (S27). That is, for the power vehicle with the number n, the brake share is set at 100%.

When the stored charge quantity (state of charge) is smaller than the set value B2 and of the set value B1 or larger (S28: YES), the formation management section 23A determines whether the number of the vehicles with the set value B3 or higher in the train 1 is 0 (S29). If there exists no vehicle with the set value B3 or higher, and the number of the vehicles is 0 (S29: YES), the formation management section 23A sets K2_n=100% (S31). When there exist vehicles with the set value B3 or higher, and the number of the vehicles is not 0 (S29: NO), the formation management section 23A sets K2_n=150% (S32). That is, for the power vehicle with the number n, the brake share is set at 150% so that they can pick up the brake force insufficiency due to presence of the vehicles with the set value B3 or higher.

When the stored charge quantity (state of charge) is smaller than the set value B1 (S28: NO), the formation management section 23A determines whether the number of the vehicles of the set value B3 or higher in the train 1 is 0 (S30). If there exists no vehicle of the set value B3 or higher, and the vehicle number is 0 (S30: YES), the formation management section 23A sets K2_n=100% (S33). When there exist the vehicles of the set value B3 or higher, and the vehicle number is not 0 (S30: NO), the formation management section 23A sets K2_n=200% (S34). That is, for the power vehicle with the number n, as there is an insufficient state of charge, the brake (regeneration) share is set at 200%, so that it picks up the brake force insufficiency due to presence of the vehicles of the set value B3 or higher.

Then, the formation management section 23A increments the variable n (S35), and determines whether the variable n is greater than the number (N) of the power vehicles in the train 1 (S36). When the variable n is greater than the number (N) of the power vehicles of the train 1 (S36: YES), it is determined that the brake shares for all of the power vehicles in the train 1 have been computed, so the process comes to an end. When the variable n is the number (N) of the power vehicles of the train 1 or smaller (S36: NO), it returns to step S22, and the brake share of the next power vehicle is computed.

Also, it is also possible to set the brake share coefficients (K21 through K12_N) as continuous functions of SOC_{—}1 through SOC_N. The level classification and the brake share coefficients (0%, 50%, 100%, 150%, 200%) shown in the flow chart in FIG. 4 are merely an example, and they may be set corresponding to the actual state of the connected power vehicles correlated to the capacity of the power vehicles.

The formation management section 23A notifies the hybrid vehicles with the computed brake instruction values (BRef_{—}1 through BRef_N). According to the brake instruction values of the formation management section 23A, the controllers of the hybrid vehicles carry out the brake (regeneration) operation. Here, the brake instruction value may also be an inverter current instruction, an inverter torque instruction, or a regenerated power instruction. Due to the brake shares, there is less dispersion in the stored charge quantities of the electric storage devices of the hybrid vehicles of the train 1. Consequently, it is possible to make a high-efficiency use of the electric storage devices of the hybrid vehicles connected with each other, so that it is possible to improve the energy-conservation performance for the overall train 1 while driving.

Then, on the basis of the stored charge quantities of the electric storage devices of the respective hybrid vehicles, the formation management section 23A controls the charging of the electric storage devices of the respective hybrid vehicles. Specifically, the formation management section 23A computes the stored charge quantities of the respective hybrid vehicles according to the following listed formula (3).

$$\begin{matrix}[ Numeric 3 ] & \\ \begin{matrix}CRef\_ 1 = f 3 ( SOC\_ 1 ) = K 3 ( SOCA - SOC\_ 1 ) \\ ⋮ \\ CRef\_N = f 3 ( SOC\_N ) = K 3 ( SOCA - SOC\_N )\end{matrix} \} & ( 3 )\end{matrix}$$

Here, the underbars and the 1 through N annexed letters indicate the numbers of the power vehicles. For example, CRef1 indicates a charging instruction value of the first power vehicle 11A, and CRef_N indicates a charging instruction value of the n^{th} power vehicle 11n. Also, SOCA represents a preset fully charged index value. f3( ) is a function for computing the necessary charged quantity corresponding to the current stored charge quantity (state of charge). K3( ) is a function for computing the necessary changed quantity from the current stored charge quantity and the fully charged index value. As shown in formula (3), the function f3( ) for computing the charged quantity is equal to a difference between the fully charged index value SOCA and the stored charge quantities SOC_{—}1 through SOC_N.

Also, it is possible to set the function f3( ) for computing the charged quantity as a continuous function of SOC_{—}1 through SOC_N. The formation management section 23A notifies the vehicle information controllers of the hybrid vehicles about the computed stored charge quantities as the charging instruction values (CRef_{—}1 through CRef_N). According to the notified charging instruction value, the vehicle information controller of each hybrid vehicle controls the charging to the electric storage device.

Here, the charging instruction values (CRef_{—}1 through CRef_N) may be any of an engine output power instruction, a generator excitation current instruction, a converter power generation quantity instruction, a converter current instruction, and a chopper current instruction.

With the charging instruction, there is less dispersion in the stored charge quantities of the electric storage devices of the hybrid vehicles in the train 1. Consequently, it is possible to make a high-efficiency use of the electric storage devices of the hybrid vehicles connected with each other, so that it is possible to improve the energy-conservation performance for the overall train 1 while running.

Then, on the basis of the stored charge quantities of the electric storage devices of the hybrid vehicles, the formation management section 23A controls the charging times of the electric storage devices of the hybrid vehicles. More specifically, the formation management section 23A computes the charging times of the hybrid vehicles according to the following listed formula (4).

$$\begin{matrix}[ Numeric 4 ] & \\ \begin{matrix}TRef\_ 1 = f 4 ( SOC\_ 1 ) = K 4 ( SOCA - SOC\_ 1 ) \\ ⋮ \\ TRef\_N = f 4 ( SOC\_N ) = K 4 ( SOCA - SOC\_N )\end{matrix} \} & ( 4 )\end{matrix}$$

Here, the underbars and the 1 through N annexed letters indicate the numbers of the power vehicles. For example, TRef_{—}1 indicates a charging time instruction value of the first power vehicle 11A, and TRef_N indicates a charging time instruction value of the n^{th} power vehicle 11n. Also, SOCA represents a preset fully charged index value. f4( ) is a function for computing the necessary charging time corresponding to the current stored charge quantity (state of charge). K4( ) is a function for computing the necessary charging time from the current stored charge quantity and the fully charged index value. As shown in formula (4), the function f4( ) for computing the charging time is equal to a difference between the fully charged index value SOCA and the stored charge quantities SOC_{—}1 through SOC_N.

Also, it is possible to set the function f4( ) for computing the charging time as a continuous function of SOC_{—}1 through SOC_N. The formation management section 23A notifies the vehicle information controllers of the hybrid vehicles about the computed charging times as the charging time instruction values (TRef_{—}1 through TRef_N). According to the notified charging time instruction value, the vehicle information controller of each hybrid vehicle controls the charging time for the electric storage device.

With the charging time instruction, there is less dispersion in the stored charge quantities of the electric storage devices of the hybrid vehicles in the train 1. Consequently, it is possible to make a high-efficiency use of the electric storage devices of the hybrid vehicles connected with each other, so that it is possible to improve the energy-conservation performance for the overall train 1 while driving.

In addition, on the basis of the temperatures of the electric storage devices of the hybrid vehicles, the formation management section 23A controls the load shares (power running shares, brake shares) and the charging so that the temperatures of the electric storage devices of the hybrid vehicles become the same. More specifically, for a vehicle having the electric storage device with a lower temperature, the load share is adjusted so that charging/discharge is carried out with the electric storage device so that the self heat generation of the electric storage device is increased. As a result, the temperatures of the electric storage devices of the hybrid vehicles become the same.

For example, as shown in formula (5), for the respective hybrid vehicles, the power running instruction values (PRef_{—}1 through PRef_N), the brake instruction values (BRef_{—}1 through BRef_N), the charging instruction values (CRef_{—}1 through CRef_N), and the charging time instruction values (TRef_{—}1 through TRef_N) are computed.

$$\begin{matrix}[ Numeric 5 ] & \\ \begin{matrix}PRef\_ 1 = f 5 ( Temp\_ 1 ) , BRef\_ 1 = f 6 ( Temp\_ 1 ) , CRef\_ 1 = f 7 ( Temp\_ 1 ) , TRef\_ 1 = f 8 ( Temp\_ 1 ) \\ ⋮ \\ PRef\_N = f 5 ( Temp\_N ) , BRef\_N = f 6 ( Temp\_N ) , CRef\_N = f 7 ( Temp\_N ) , TRef\_N = f 8 ( Temp\_N )\end{matrix} \} & ( 5 )\end{matrix}$$

Here, the underbars and the 1 through N annexed letters indicate the numbers of the power vehicles. Temp_{—}1 through Temp_N represent the temperatures of the electric storage devices of the hybrid vehicles (1 through N). f5( ) is a function for computing the power running instruction values corresponding to the temperatures of the electric storage devices. f6( ) is a function for computing the brake instruction values corresponding to the temperatures of the electric storage devices. f7( ) is a function for computing the charging instruction values corresponding to the temperatures of the electric storage devices. f8( ) is a function for computing the charging time instruction values corresponding to the temperatures of the electric storage devices.

The formation management section 23A notifies the vehicle information controllers of the hybrid vehicles with the computed power running instruction values (PRef_{—}1 through PRef_N), the brake instruction values (BRef_{—}1 through BRef_N), the charging instruction values (CRef_{—}1 through CRef_N), and the charging time instruction values (TRef_{—}1 through TRef_N). According to the notified instruction values, the vehicle information controllers of the hybrid vehicles control the power running, the brake, and the charging in the electric storage devices. Consequently, there is less dispersion in the temperatures of the electric storage devices of the hybrid vehicles in the train 1. Consequently, it is possible to make a high-efficiency use of the electric storage devices of the hybrid vehicles connected with each other, so that it is possible to improve the energy-conservation performance for the overall train 1 while driving.

In addition, on the basis of the degradation states of the electric storage devices of the hybrid vehicles, the formation management section 23A controls the load shares (power running shares and brake shares) and changing them so that the degradation states of the electric storage devices of the hybrid vehicles become the same. More specifically, for a vehicle with more advanced degradation in the electric storage device (with a larger degradation index), the load share is adjusted so that charging/discharge is not carried out for the electric storage device. The insufficiency in the power running output and brake force caused by such adjustment is picked up by the vehicles without advanced degradation (with small degradation index values).

For example, as shown in formula (6), the following instruction values of the hybrid vehicles are computed: the power running instruction values (PRef_{—}1 through PRef_N), the brake instruction values (BRef_{—}1 through BRef_N), the charging instruction values (CRef_{—}1 through CRef_N), and the charging time instruction values (TRef_{—}1 through TRef_N).

$$\begin{matrix}[ Numeric 6 ] & \\ \begin{matrix}PRef\_ 1 = f 9 ( L\_ 1 ) , BRef\_ 1 = f 10 ( L\_ 1 ) , CRef\_ 1 = f 11 ( L\_ 1 ) , TRef\_ 1 = f 12 ( L\_ 1 ) \\ ⋮ \\ PRef\_N = f 9 ( L\_N ) , BRef\_N = f 10 ( L\_N ) , CRef\_N = f 11 ( L\_N ) , TRef\_N = f 12 ( L\_N )\end{matrix} \} & ( 6 )\end{matrix}$$

Here, the underbars and the 1 through N annexed letters indicate the numbers of the power vehicles. L_{—}1 through L_N are the degradation indexes of the electric storage devices of the hybrid vehicles (1 through N). f9( ) is a function for computing the power running instruction values corresponding to the degradation indexes of the electric storage devices. f10( ) is a function for computing the brake instruction values corresponding to the degradation indexes of the electric storage devices. f11( ) is a function for computing the charging instruction values corresponding to the degradation indexes of the electric storage devices. f12( ) is a function for computing the charging time instruction values corresponding to the degradation indexes of the electric storage devices.

The formation management section 23A notifies the vehicle information controllers of the hybrid vehicles with the computed power running instruction values (PRef_{—}1 through PRef_N), the brake instruction values (BRef_{—}1 through BRef_N), the charging instruction values (CRef_{—}1 through CRef_N), and the charging time instruction values (TRef_{—}1 through TRef_N). According to the notified instruction values, the vehicle information controllers of the hybrid vehicles control the power running, the brake, and the charging in the electric storage devices. Consequently, there is less dispersion in the degradation states of the electric storage devices of the hybrid vehicles in the train 1. Consequently, it is possible to make a high-efficiency use of the electric storage devices of the hybrid vehicles connected with each other, so that it is possible to improve the energy-conservation performance for the overall train 1 while driving.

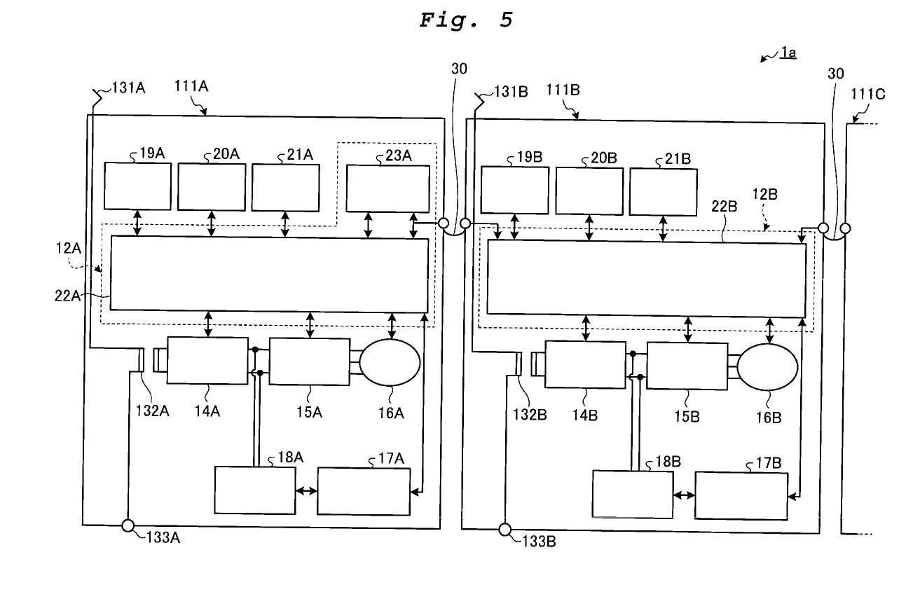

FIG. 5 is a block diagram illustrating an example of the configuration of a train la according to a second embodiment of the present invention. As shown in FIG. 5, for a first power vehicle 111A, a second power vehicle 111B, a third power vehicle 111C, etc. that form the train la in the second embodiment, a main power supply is a single phase AC power supplied from an elevated line (not shown). That is, the first power vehicle 111A, the second power vehicle 111B and the third power vehicle 111C are hybrid vehicles driven by an AC power supplied from the elevated lines and the power supplied from electric storage devices. More specifically, the first power vehicle 111A has a power collecting unit 131A that has the AC power supplied from the elevated line input to it, a main transformer 132A that transforms the input AC power and supplies the transformed power to the converter 14A, and wheels 133A that are grounded. Similar to the first power vehicle 111A, the second power vehicle 111B also has a power collecting unit 131B, a main transformer 132B, and wheels 133B. The third power vehicle 111C, etc. also have the same configuration as described above.

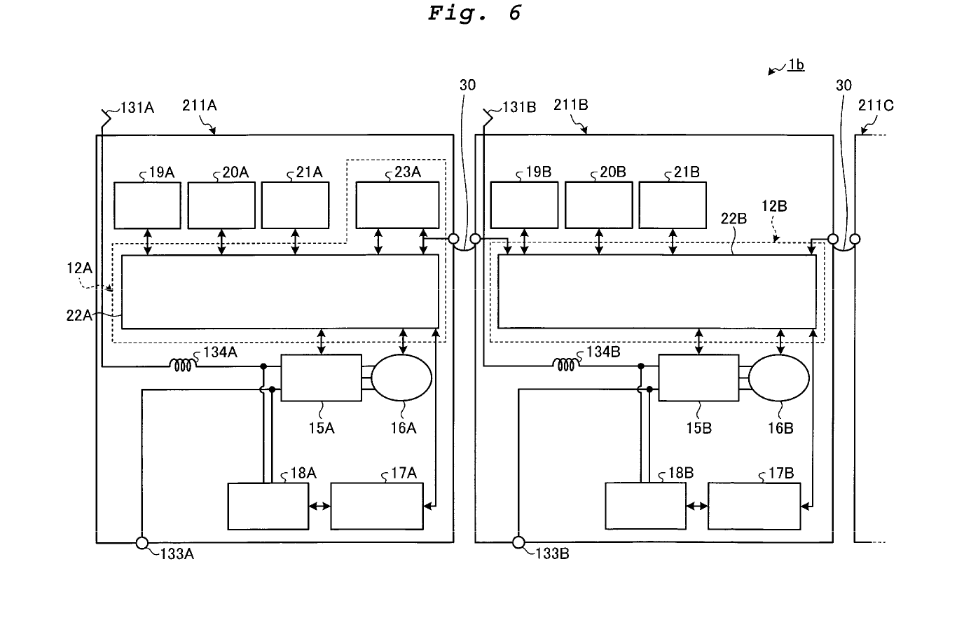

FIG. 6 is a block diagram illustrating an example of the configuration of a train 1b according to a third embodiment of the present invention. As shown in FIG. 6, for a first power vehicle 211A, a second power vehicle 211B, a third power vehicle 211C, etc. that form the train 1b in the third embodiment, a main power supply is a single phase DC power supplied from an elevated line (not shown). That is, the first power vehicle 211A, the second power vehicle 211B, and the third power vehicle 211C are hybrid vehicles driven by a DC power supplied from the elevated lines and the power supplied from electric storage devices. Specifically the first power vehicle 211A has a configuration in which the DC power input from the elevated line via the power collecting unit 131A is input into the inverter 15A via a reactor 134A. In the same way, the second power vehicle 211B that is another power vehicle other than the first power vehicle 211A also has a configuration in which the DC power input from the elevated line via the power collecting unit 131B is input to the inverter 15B via a reactor 134B. The third power vehicle 211C etc. also have the same configuration as described above.

As explained above, as the main power supply, either the power supply that has the power generated by a generator or an AC/DC power supply supplied from an elevated line may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller for a first hybrid vehicle which is one of a set of hybrid vehicles each having an electric storage device, comprising:
a monitoring unit configured to detect an amount of electric charge stored in the electric storage device of the first hybrid vehicle;
a communication unit configured to carry out communication with a communication unit of at least a second hybrid vehicle, which is another one of the hybrid vehicles in the set to acquire an amount of electric charge stored in the electric storage device of the second hybrid vehicle; and
a control unit configured to determine load shares of the first and second hybrid vehicles during operation of the first and second hybrid vehicles, on the basis of the amount of electric charge stored in the electric storage devices thereof.

2. The controller according to claim 1, wherein the load shares include first and second load shares, and power running instructions for the first and second hybrid vehicles are determined using the first and second load shares, respectively.

3. The controller according to claim 2, wherein the monitoring unit is configured to detect a temperature of the electric storage device and the power running instruction for the first hybrid vehicle is determined based on the detected temperature.

4. The controller according to claim 2, wherein the monitoring unit is configured to detect a degradation state of the electric storage device and the power running instruction for the first hybrid vehicle is determined based on the detected degradation state.

5. The controller according to claim 1, wherein the load shares include first and second load shares, and braking instructions for the first and second hybrid vehicles are determined using the first and second load shares, respectively.

6. The controller according to claim 5, wherein the monitoring unit is configured to detect a temperature of the electric storage device and the braking instruction for the first hybrid vehicle is determined based on the detected temperature.

7. The controller according to claim 5, wherein the monitoring unit is configured to detect a degradation state of the electric storage device and the braking instruction for the first hybrid vehicle is determined based on the detected degradation state.

8. A system of hybrid vehicles connected in series, comprising:
a first hybrid vehicle including an electric storage device, and a monitoring unit configured to detect an amount of electric charge stored in the electric storage device; and
a second hybrid vehicle including an electric storage device, and a monitoring unit configured to detect an amount of electric charge stored in the electric storage device,
wherein load shares for the first and second hybrid vehicles are respectively determined from an amount of electric charge stored in the electric storage devices of the first and second hybrid vehicles.

9. The system according to claim 8, wherein the load shares include first and second load shares, and power running instructions for the first and second hybrid vehicles are determined using the first and second load shares, respectively.

10. The system according to claim 9, wherein the monitoring unit of each hybrid vehicle is configured to detect a temperature of the electric storage device of the respective hybrid vehicle and the power running instruction for the respective hybrid vehicle is determined based on the detected temperature.

11. The system according to claim 9, wherein the monitoring unit of each hybrid vehicle is configured to detect a degradation state of the electric storage device of the respective hybrid vehicle and the power running instruction for the respective hybrid vehicle is determined based on the detected degradation state.

12. The system according to claim 8, wherein the load shares include first and second load shares, and braking instructions for the first and second hybrid vehicles are determined using the first and second load shares, respectively.

13. The system according to claim 12, wherein the monitoring unit of each hybrid vehicle is configured to detect a temperature of the electric storage device of the respective hybrid vehicle and the braking instruction for the respective hybrid vehicle is determined based on the detected temperature.

14. The system according to claim 12, wherein the monitoring unit of each hybrid vehicle is configured to detect a degradation state of the electric storage device of the respective hybrid vehicle and the braking instruction for the respective hybrid vehicle is determined based on the detected degradation state.

15. In a system of hybrid vehicles connected in series, each hybrid vehicle including an electric storage device, a method of determining load shares for each hybrid vehicle, comprising the steps of:
comparing an amount of electric charge stored in the electric storage device of the hybrid vehicle against first, second, and third thresholds; and
determining the load share for the hybrid vehicle to be a first load share value if the amount of electric charge stored in the electric storage device is between the first and second thresholds; and
determining the load share for the hybrid vehicle to be a second load share value if the amount of electric charge stored in the electric storage device is between the second and third thresholds.

16. The method of claim 15, further comprising:
determining the load share for the hybrid vehicle to be a third load share value if the amount of electric charge stored in the electric storage device is less than the first threshold.

17. The method of claim 16, further comprising:
generating a power running instruction for the hybrid vehicle using the load share for the hybrid vehicle.

18. The method of claim 15, further comprising:
determining the load share for the hybrid vehicle to be a third load share value if the amount of electric charge stored in the electric storage device is greater than the first threshold.

19. The method of claim 18, further comprising:
generating a braking instruction for the hybrid vehicle using the load share for the hybrid vehicle.

20. The method of claim 15, wherein the load share for the hybrid vehicle indicates a percentage of a reference power running value or a reference braking value to use for the hybrid vehicle.
